(19) United States
(12) Patent Application Publication
(10) Pub. No.: US 2025/0314234 A1
(43) Pub. Date: Oct. 9, 2025

(54) PASSIVE TRAILING EDGE INCLUDING CHORD EXTENSIONS

(71) Applicant: Gulf Wind Technology, Avondale, LA (US)

(72) Inventor: Peter Anthony BROOME, Park Ridge, IL (US)

(73) Assignee: Gulf Wind Technology, Avondale, LA (US)

(21) Appl. No.: 19/171,519

(22) Filed: Apr. 7, 2025

Related U.S. Application Data
(60) Provisional application No. 63/575,931, filed on Apr. 8, 2024.

(51) Int. Cl. F03D 1/06

(52) U.S. Cl. CPC F03D 1/069; F05B 2240/304; F05B 2280/6003

(57) ABSTRACT

A wind turbine rotor blade is disclosed that includes a blade body having a shape that generates a lift when impacted by an incident airflow. The blade body includes a pressure side and a suction side joining at a leading edge and a trailing edge, and a chord extension system mechanically coupled with the trailing edge. The chord extension system may be configured to enhance an aerodynamic performance of the wind turbine rotor blade. The chord extension system may include either a flat plate or a serration. The chord extension system may include a multi-layer composite body that includes a first composite layer having a first elasticity parameter and a second composite layer mechanically coupled with the first composite layer. The second composite layer may have a second elasticity parameter different from the first elasticity parameter.

### CROSS-REFERENCE TO RELATED APPLICATIONS

This non-provisional patent application claims priority to U.S. provisional patent application No. 63/575,931, filed on Apr. 8, 2024, titled “Passive trailing edge including chord extensions”, the contents of which are incorporated herein by reference in their entirety and should be considered part of this specification.

### BACKGROUND

Wind power is considered one of the cleanest, most environmentally friendly energy sources presently available, and wind turbines have gained increased attention in this regard. As the demand for wind energy continues to grow, there is an increasing emphasis on improving the efficiency of wind energy conversion systems. Wind turbine blades play a crucial role in capturing and converting wind energy into electrical power. Conventional designs, however, are often constrained by the trade-offs between aerodynamic efficiency and structural integrity. Specifically, traditional wind turbine blades face a number of challenges associated with aerodynamic drag, noise generation, and fatigue, which can limit their overall efficiency. In addition, these blades may be slow in their response to severe and unpredictable gust loads causing structural stress and increased fatigue degradation. There remains a need to optimize aerodynamic performance and passive load shedding while protecting and reducing structural stress on wind turbine blades.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIG. 1 is an illustrative perspective view of a conventional wind turbine.

FIG. 2 is an illustrative perspective view of a rotor blade of a wind turbine of FIG. 1.

FIG. 3 is an illustrative top view of a rotor blade of a wind turbine of FIG. 1.

FIG. 4 is an illustrative cross-sectional view of a conventional rotor blade of a wind turbine.

FIG. 5A is an illustrative cross-sectional view of a rotor blade of a wind turbine, in accordance with an embodiment of this disclosure.

FIG. 5B is an illustrative top view of a chord extension attached to an underside of the trailing edge of a rotor blade of a wind turbine, in accordance with an embodiment of this disclosure.

FIG. 6A is an illustrative cross-sectional view of a rotor blade of a wind turbine, in accordance with an embodiment of this disclosure.

FIG. 6B is an illustrative top view of a chord extension attached to an underside of the trailing edge of a rotor blade of a wind turbine, in accordance with an embodiment of this disclosure.

FIG. 7 is an illustrative view of a multi-layer composite structure, in accordance with an embodiment of this disclosure.

FIG. 8 is an illustrative view of a multi-layer composite structure, in accordance with an embodiment of this disclosure.

FIG. 9A is an illustrative view of the composite structure of FIG. 7 or FIG. 8 in the absence of external load condition.

FIG. 9B is an illustrative view of the composite structure of FIG. 7 or FIG. 8 under external load condition.

FIG. 9C is an illustrative view of the composite structure of FIG. 7 or FIG. 8 under ceased or withdrawn external load condition.

FIG. 10A is an illustrative view of the composite structure of FIG. 7 or FIG. 8 in the absence of external load condition.

FIG. 10B is an illustrative view of the composite structure of FIG. 7 or FIG. 8 under external load condition.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

The present disclosure relates to systems and methods of constructing passive trailing edge assemblies of wind turbine blades such that the trailing edge assemblies are enabled with predictable buckling responses under mechanical forces associated with extreme weather conditions. The systems and methods described herein may be designed to enhance the performance and efficiency of wind turbines and further, to optimize aerodynamic performance and passive load-shedding while protecting and reducing structural stress. Specifically, various implementations of the disclosed subject matter relate generally to and may provide improvements in trailing edge assemblies in the way these assemblies respond to elastic buckling (or structural buckling) loads below and beyond critical buckling load yield points.

In recent years, there has been a significant focus on mitigating the adverse effects of aerodynamic drag, noise, and fatigue in wind turbine blades. The trailing edge systems and methods of this disclosure aim to construct solid-state passive trailing edges that structurally resist a linear load until a controlled yield point is reached. At this point, a controlled deflection may occur until the buckling load is reduced back to a sub-deflection level, when the laminates constituting the trailing edges return to their flat baseline shapes. This is achieved by constructing a singular and homogenous composite structure that integrates two or more composite layers having diverse fiber architectures, resin matrices, mixed materials, plastics and the like.

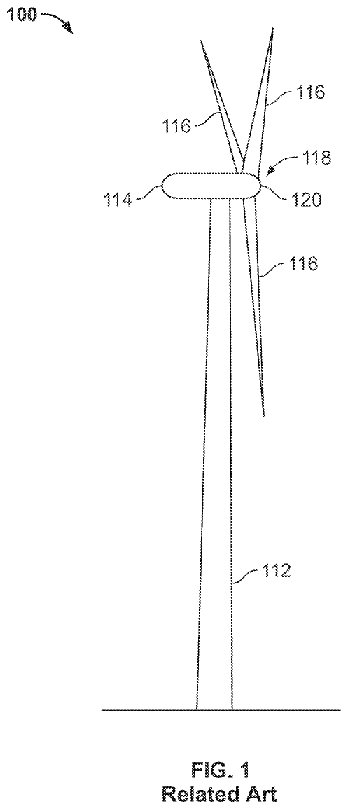

FIG. 1 is an illustrative perspective view of a conventional wind turbine 100. As shown, the wind turbine 100 includes a tower 112 with a nacelle 114 mounted thereon. The wind turbine 100 also includes a rotor hub 118 having a rotatable hub 120 with a plurality of rotor blades 116 mounted thereto, which is in turn is connected to a main flange that turns a main rotor shaft (not shown). The wind turbine power generation and control components are typically housed within the nacelle 114. The view of FIG. 1 is provided for illustrative purposes only to place the present disclosure in an exemplary field of use. It should be appreciated that the disclosure is not limited to any particular type of wind turbine configuration.

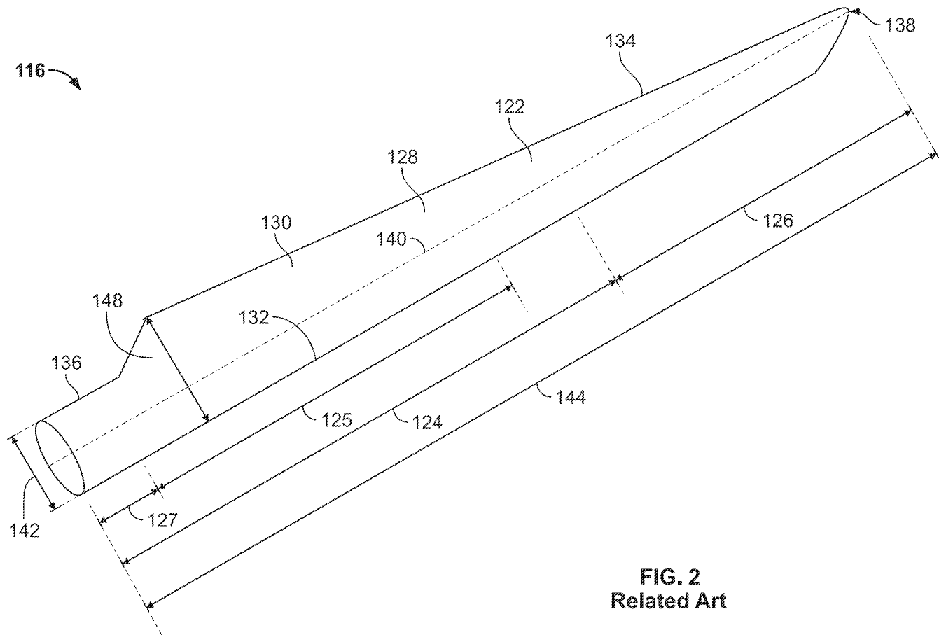

FIG. 2 is an illustrative perspective view of a rotor blade of a wind turbine, such as may be used with the turbine of FIG. 1 or other similar devices and structures. The rotor blade 116 includes one or more features configured to reduce noise associated with high wind speed conditions. As shown, the rotor blade 116 includes an aerodynamic body 122 having an inboard region 124 and an outboard region 126. The inboard and outboard regions 124, 126 define a pressure side 128 and a suction side 130 extending between a leading edge 132 and a trailing edge 134. The inboard region 124 includes a blade root 136, whereas the outboard region 126 includes a blade tip 138.

The rotor blade 116 defines a pitch axis 140 relative to the rotor hub 118 (FIG. 1) that typically extends perpendicularly to the rotor hub 118 and the blade root 136 through the center of the blade root 136. A pitch angle or blade pitch of the rotor blade 116, i.e., an angle that determines a perspective of the rotor blade 116 with respect to the air flow past the wind turbine 100, may be defined by rotation of the rotor blade 116 about the pitch axis 140. In addition, the rotor blade 116 further defines a chord 142 and a span 144. More specifically, as shown in FIG. 2, the chord 142 may vary throughout the span 144 of the rotor blade 116. Thus, a local chord may be defined for the rotor blade 116 at any point on the blade 116 along the span 144.

In certain embodiments, the inboard region 124 may include from about 0% to about 50% of the span 144 of the rotor blade 116 from the blade root 136 in the span-wise direction, whereas the outboard region 126 may include from about 50% to about 100% of the span 144 of the rotor blade 116 from the blade root 136. More specifically, in particular embodiments, the inboard region 124 may range from about 0% span to about 40% of the span 144 of the rotor blade 116 from the blade root 136 in the span-wise direction and the outboard region 126 may range from about 40% span to about 100% span 144 from the blade root 136 of the rotor blade 116. As used herein, terms of degree (such as “about,” “substantially,” etc.) are understood to include a +/−10% variation.

Referring further to FIG. 2, the inboard region 124 may include a transitional region 125 of the rotor blade 116 that includes a maximum chord 148. More specifically, in one embodiment, the transition region 125 may range from about 15% span to about 30% span of the rotor blade 16. In addition, as shown, the rotor blade 116 may also include a blade root region 127 inboard of the maximum chord 148 and within the inboard region 124.

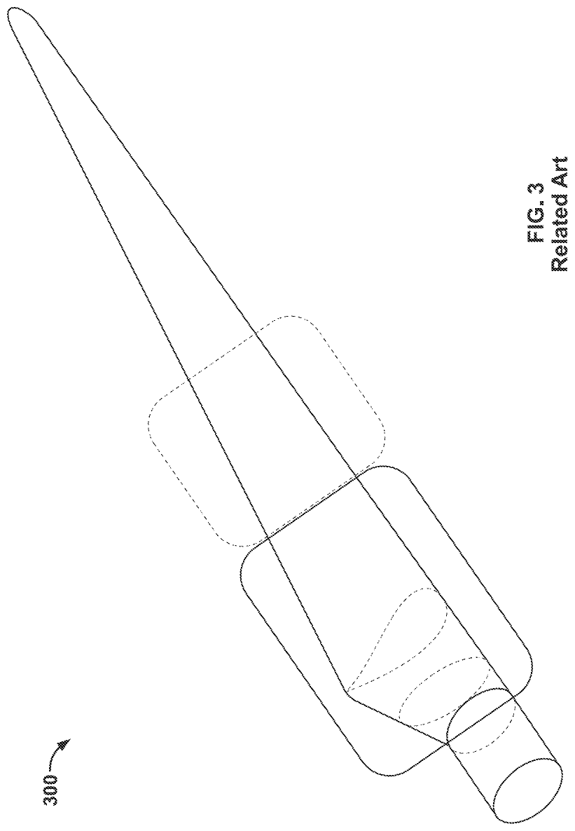

FIG. 3 is an illustrative top view of a rotor blade body 300, such as for use with a wind turbine of FIG. 1 or similar devices and structures. Referring to FIG. 3, for regular (not stalled) flow conditions, the lift and drag forces are functions of the angle of attack of the air relative to the airfoil. The exact dependency of lift and drag forces on angle of attack has to be determined experimentally or by numerical simulation and depends both on the airfoil shape and on the Reynolds number. These relationships are conventionally expressed in terms of the lift and drag coefficients, C_{L} and C_{D}, respectively, defined via with L and D the lift and drag forces, respectively, p the density of the air, S the planform area of the blades, and V the velocity of the air relative to the moving blades.

$$\begin{matrix}L = \frac{1}{2} ρ {V}_{rel}^{2} {cC}_{L} \\ \begin{matrix}{C}_{L} = \frac{L}{\frac{ρ}{2} {SV}^{2}} , & {C}_{D} \frac{D}{\frac{ρ}{2} {SV}^{2}}\end{matrix}\end{matrix}$$

Taking the vector product of the force vector F with the radius vector of the turbine arm, one can calculate the torque T that each turbine blade generates. This torque will thus be a function of the wind speed U∞, local tip-speed ratio TSR*, angle of attack of the blade α and of the rotational angle θ, so we have T=T (U∞, TSR*, α, θ). It is important to note that, unless the angle of attack α is chosen judiciously, this torque will be negative (against the direction of rotation of the turbine), and that, for each set of the parameters given above, there is an optimal angle of attack at each position of the blade during its rotation such that the positive (driving) torque is maximized.

For wind turbines and wind turbine blades, the pressure side of the blade is also defined and known as the windward side or the upwind side, whereas the suction side is also defined and known as the leeward side or the downwind side. Typically, the length of the wind turbine blade may be at least 40 meters, or at least 50 meters, or at least 60 meters. The blades may even be at least 70 meters, or at least 80 meters. Blades having a length of at least 90 meters or at least 100 meters are also possible.

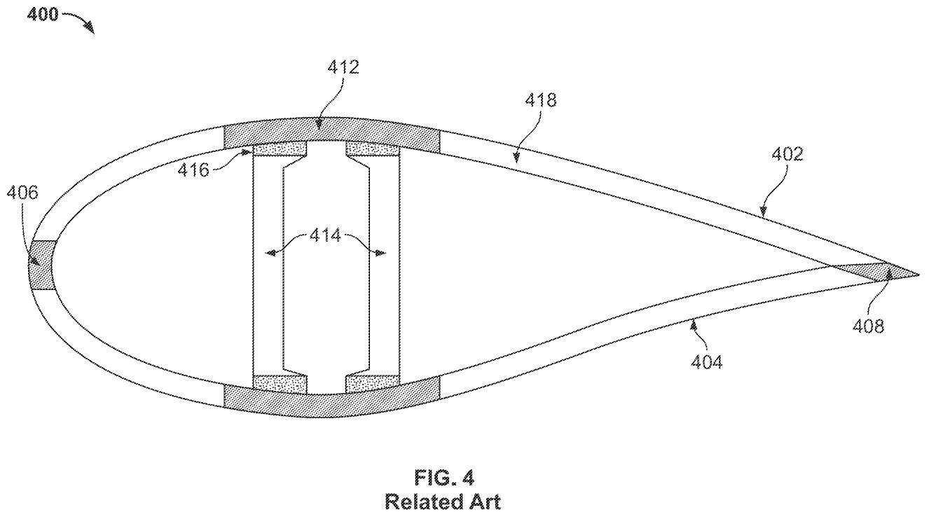

The blade and in particular, the blade body 300 may include a shell structure explained in more detail below, in relation to FIG. 4. The blade body 300 typically includes a longitudinally extending reinforcement section made of fiber layers. The reinforcement section, also called a main laminate, may typically extend from a root region proximate to a rotor hub to a tip region distant from the rotor hub, through a transition region extending between the root region and the tip region.

By recent industry trends, rapid growth and development of wind energy projects into low wind speed geographies indicate a growth in low wind speed markets, internationally. Industry analysis further indicates that the average specific power of wind turbines installed in 2021 has decreased from the 1998-1998 figure of 393 W/m2 to 231 W/m2. Lower specific power ratings for a wind turbine indicate a growth in the rotor diameter/blade length for a given rating. For example, the rotor diameters have increased to 127.5 m in 2021, up 2% from 2020 and 165% from 1998-1999. To capture additional energy from these low wind speed sites, turbines installed in 2021 have hub heights that increased to almost 94 m, up 4% from 2020 and 66% from 1998-1999 levels. The industry analysis is further supported by improved aerodynamic designs, including aerodynamic controls technology.

The expansion of onshore wind turbines into lower wind speed sites and the potential development activities for offshore wind turbines may subject wind turbines with larger rotors and taller hub heights to more extreme wind conditions associated with hurricanes and tropical storms. Further, an analysis of the return period for hurricanes that have passed within 50 nautical miles of various stations along the coastline data indicates that the return periods in several geographies of interest such as the Gulf of Mexico and the Southeast Coastline of the USA may have a return period for Category 1+ hurricanes which is less than one half of the average return period in the hurricane-prone geographies. This suggests that turbine and rotor designs for these sites may need to consider hurricane induced loading during the 20-to-30-year operational lifetime of the wind energy project.

As rotor blade lengths increase, whether as part of the industry growth trends or due to specific designs for low wind sites, the net result is that the variation in flow conditions incident on the blade cross sections increases. This increased variation in wind speed, veer, gusts, and upflow result in increased variation in the aerodynamic loading on the blades. In turn, the increased loading on the blades results directly in increased cost of the blades as additional material is added to ensure strain levels remain within material limits. In addition to the increased blade weight and cost, the turbine cost due to the additional load variation also may increase as this aerodynamic load is passed into the turbine structure and drivetrain, leading to increases in the cost of energy (COE) for wind energy installations.

Wind turbine blades are typically subjected to a series of load cases (or scenarios) in order to define the extreme/ultimate and fatigue loading environment. Several extreme load cases that may prove to be design limiting include design load cases (DLC) for extreme turbulence model, extreme wind shear, extreme operating gust with grid loss (and potentially without grid loss, but this is not an explicit International Electrotechnical Commission or “IEC” load case), extreme wind speeds with significant yaw misalignment, and extreme wind speed with a fault condition (blade failed to pitch).

These load cases tend to be design limiting as the aerodynamic forces on the blade cross sections increase rapidly (28-35% increase in wind speed), with discrete events occurring with a rise time of one to two seconds. Extreme operating gust, for example, may result in a 10 m/s increase in wind speed, which occurs in under two seconds, during the overall 10-second-long event. This rapid change in wind speed may give rise to rapid changes in the local angle of attack, on the order of 10 degrees occurring over 1-2 seconds. This increase in angle of attack may lead to a dramatic increase in lift, up to 80%, and a similar 40% increase in blade root flapwise bending moment. Outside the industry-standard load cases, there may be other examples of events that may occur, particularly during peak wind events such as microbursts or other extreme wind events, where rapid wind speed and direction changes can occur with similar magnitudes and time constants.

There is a perceived need to develop a blade trailing edge (TE) design that can passively reduce peak loads associated with rapid changes in local angle of attack occurring over rise times of two seconds or less.

Traditional approaches to manage blade loading may include hardening the structure to survive the extreme events, sensing and controlling the turbine level response to the event, early-stage research into passive and active aerodynamic control strategies and the like.

Considering an example traditional approach of hardening the blade structure, currently there are not many opportunities to dynamically shed the peak loads during peak load events, and instead, the loads from multiple design load cases collectively form the design envelop for the blade. The structure of the blade, including the spar cap width and thickness as well as amount of structural reinforcement in the shells, most often, may be sized by the limiting envelop. For the spar cap, particularly for carbon spars used today, there is a linear relationship between the applied compressive load and the amount of material needed to ensure that the strain levels remain below allowable limits. Similarly, these extreme loads often lead to panel buckling of the pressure or suction side shells, with a similar relationship between loads and structural reinforcement.

In addition to managing the peak loads with structural reinforcements, modern turbines often use a variety of control mechanisms to manage peak loads. Controllers, in such instances, may be installed to evaluate the measured load indicators and command responses, such as pitching the blades to feather to reduce the angle of attack and thus to reduce the aerodynamic loads. The ability of the turbine to control peak loads with blade pitch activity, may however, be limited by the blade weight, pitch system capacity, and the response time of the turbine. Typical maximum pitch rates for modern wind turbines may be of the order of 1 to 2 degrees per second. The pitch rates, for the control system response alone, may be well below the rate at which the local angle of attach changes (10 degrees over 1-2 seconds). This is further complicated by the response time associated with the development of the load, measurement of the increased load by the turbine, and control decision to initiate a response action. Therefore, approaches that instead focus on the alleviation of the load directly at the blade level are needed.

In addition to turbine controller and structural reinforcement, a third approach to mitigating the peak aerodynamic loads is to incorporate approaches or technology into the blade that directly affect the aerodynamic loading. These approaches include blade level aero-elastic tailoring and/or use of discrete flow control technologies.

Aeroelastic tailoring is a “coupled” design approach where the blade planform shape (sweep) or structural fiber layup schedule (off-axis fibers) are tailored to induce a particular response in the blade. Traditionally aeroelastic tailoring may be used to induce a twist in the blade cross sections under load, thereby reducing the angle of attack and the forces imparted to the blade. According to industry reports, reductions of up to 6% in COE are possible, with a vision of up to 10% could be achieved by growing the rotor while maintaining the existing load envelope. These studies are typically conducted on shorter, and stiffer blades, for turbines in the 750 kW to 1.5 MW range. Modern blades, however, are much larger and are, relatively, more flexible than their shorter predecessors. Therefore, the blades employed today inherently take advantage of some of the benefits of aeroelastic tailoring due to their more compliant structures. For example, blade twists on modern blades may be of the order of 5 to 8 degrees, the same amount of designed aeroelastic twist targeted with previous generation swept blade concepts. Indeed, control schemes to account for and manage this induced twist on modern blades have been developed.

In addition to aero-elastic tailoring, several flow control technologies may be used on wind turbine blades. These flow control technologies may be used to increase or decrease the sectional lift generated on the blade, as described below.

In an instance, large trailing edge (TE) flaps, along with more compact flaps from the rotorcraft industry or piezoelectric actuated flaps may be used on compliant structures actuated via electromechanical means. An active TE flap may be used to reduce loads using a pressure driven active TE system. The reported results for various active TE flaps suggest that the variation in both extreme and fatigue loads may be reduced using actively actuated TE flaps. A disadvantage of these approaches, however, is that they require an active actuation method and they rely on electro/mechanical mechanism for actuating the flap and integration with a control system.

In an instance, small tabs (also known as “microtabs”), on the order of the boundary layer thickness, may be used to reduce the airfoil lift when installed on the airfoil suction surface. These small tabs are electro/mechanically deployed from the surface and they may require integration of hardware to sense and trigger deployment of the tabs. This technology has not been deployed commercially due to the obstacles of integrating the actuator into the blade and the control system of the turbine. Microspoilers may be used for shedding load with leading edges (“LE”), which has indicated significant control authority of the microspoilers on reducing the load associated with extreme shutdown load cases for a downwind rotor. Additionally, the microspoilers may also be used with upwind rotor configurations, where power production load cases produced envelop defining loads. Similar to other approaches with actuated sensors, the details of solving the actuator and control system integration will be critical to the developing of any active flow control system.

In an instance, trailing edge effectors including deployable gurney flaps, located directly on a blunt TE may be used to control loads on trailing edges. However, the approach needs physical integration with the blade and turbine controller. Alternately, similar to TE effectors and microtabs, a microflap may be used to replaces the nominal TE with a flap that is housed in the TE and can rotate +/−90 degrees, acting like a gurney flap to affect lift. This is typically an active device and it requires physical and controller integration.

In an example, stall strips may be actively deployed to fix transition around the leading edge (LE) of the airfoil, reducing the lift generated across the airfoil.

In an instance, high velocity jets may be used to blow air and control circulation of air around a rounded or semi-rounded TE. As with other technologies, they require active control, integration of the pressure tubing, and system integration with the blade and turbine.

In an instance, shape changing airfoils may be used on deformable skin and along with an electro/mechanical means of actuating a deformable member within the airfoil. This deformation then induces a change in the airfoil shape, thus allowing for load control. As with other devices, these require active sensing, actuators and control integration.

In an instance, a Fish Bone Active Camber (or “FishBAC”) TE structure may be used that includes a thin chordwise flexible beam, onto which ribs may be connected between the flexible beam and a pretensioned skin layers. An actuator then controls ‘tendons” attached to the structure that cause the beam to deflect. The control authority of the device may be effective, leading to changes in the lift coefficient of 0.5 to 0.7 for a 20% chord TE. As with other adaptive TE devices, however, it requires both a significant change in the TE architecture as well as an actuator to physically manipulate the tendons to induce the deformation.

In an instance, a selectively compliant TE structure may be used that has shown theoretical promise for of reduction normal forces on the blades by 6 to almost 50% for various TE flap lengths and amounts of deflection. One of the important elements of this approach is the development of an internal rib within the TE with a bi-modal stiffness. As the load on the TE increases, due to a gust, this loading will exceed the capacity of the initial TE structural state, causing it to deform and adopt the second state, leading to a deformation of the TE, and a reduction in the load. The bi-modal stiffness rib, however, requires the use of a corrugated suction surface in order to achieve the required deformation of the airfoil surface. This corrugation directly impacts the aerodynamics, resulting in a loss of airfoil efficiency and reduction in turbine power production during normal operation. In addition, this approach adopted still requires a device to activate to force the bi-modal stiffness rib to return to the nominal, power producing configuration.

In summary, active blade airfoil elements (leading and trailing edge), as described above, influence the loading on a wind turbine airfoil with significant control authority to reduce the peak load. Various kinds of airfoil elements have the potential to influence the blade aerodynamics to reduce loads. Integration and activation of the elements, however, are required to achieve the required effect. For example, the elements discussed above may require a means of sensing the need for deployment, a means of activation, and a mechanism by which this is integrated into a controller. Even the passive approaches discussed may still require the use of a device to return the element to its nominal position after passive deployment. As discussed above, the challenges inherent in developing flow control devices focus on the integration of the aerodynamic feature into the blade structure, providing a means or mechanism to provide the trigger to cause the controller to deploy the feature, and the overall integration of the system with the turbine controller.

To overcome these challenges, the present systems and methods relate to and describe passive load control techniques. The novel approach to passively deforming TE construction outlined above is that it enables the development of lower cost wind turbine blades and enables these rotors to enter low wind speed sites which are subject to peak extreme loads.

FIG. 4 is an illustrative cross-sectional view of a blade body 400 of a conventional rotor blade of a wind turbine. Referring to FIG. 4, the blade body 400 may be designed in a shape that generates a lift when impacted by an incident airflow. The blade body 400 may include a laminate outer shell (also referred to as “pressure side”) 402 and a laminate inner shell (also referred to as “suction side”) 404 joining at a leading edge 406 and a trailing edge 408. The outer shell 402 and the inner shell 404 may be made of a composite material. The composite material may be a resin matrix reinforced with fibers. In most cases the polymer applied is thermosetting resin, such as polyester, vinylester or epoxy. The resin may also be a thermoplastic, such as nylon, PVC, ABS, polypropylene or polyethylene, or another thermosetting thermoplastic, such as cyclic PBT or PET. The fiber reinforcement is most often based on glass fibers or carbon fibers, but may also be plastic fibers, plant fibers or metal fibers. The composite material may often include a sandwich structure including a core material, such as foamed polymer or balsawood.

Referring back to FIG. 4, the outer shell 402 and the inner shell 404 are internally supported and joined by a supporting and stiffening structure, known as “spar cap”, 412. The spar cap may include a number of supporting and stiffening column-like structures, known as “shear webs”, 414. The spar cap 412 and the shear webs 414 may be internally joined with the inner sides of the outer shell 402 and the inner shell 404 by an adhesive 416. The outer shell 402 and the inner shell 404 may be internally padded with balsa or foam 418, used as shock absorbing elements.

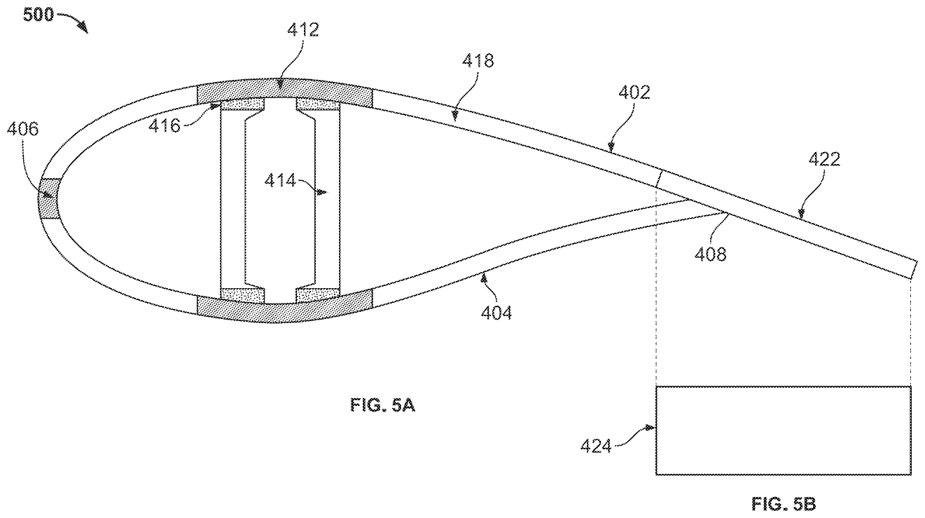

FIG. 5A is an illustrative cross-sectional view of a blade body 500 of a rotor blade of a wind turbine, in accordance with an embodiment of this disclosure. Referring to FIG. 5A, the blade body 500 may include the parts and components of a conventional rotor blade of a wind turbine, as described in relation to FIG. 4, such as outer shell 402, inner shell 404, leading edge 406, trailing edge 408, spar cap 412, shear webs 414, adhesive 416, and balsa or foam padding 418. In addition, the blade body 500 includes a chord extension system 422 mechanically coupled with the trailing edge 408 at the underside of the trailing edge 408. The chord extension system 422 may be coupled with the trailing edge 408 by an adhesive or screws or such other fastening mechanisms. The chord extension system 422 may be configured to enhance an aerodynamic performance of the wind turbine rotor blade.

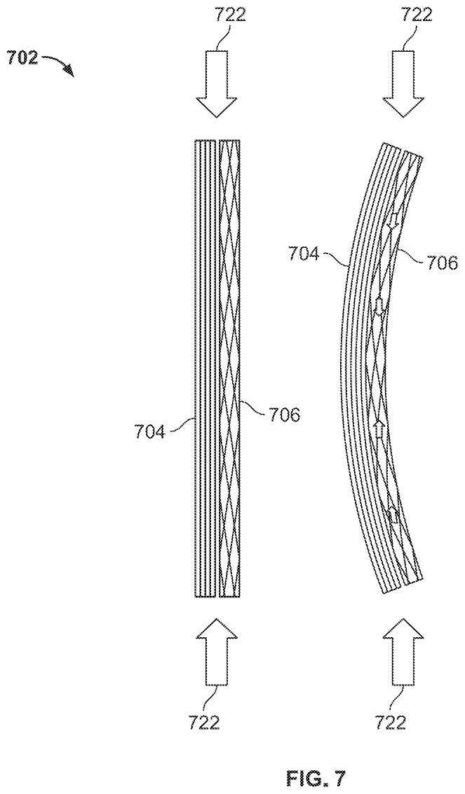

FIG. 5B is an illustrative top view of a chord extension system 422 attached to an underside of the trailing edge 408 of the blade body 500 of FIG. 5A. Referring to FIG. 5B, the chord extension system 422 may be a flat plate 424 made of a multi-layer composite body, as described in more detail below, in relation to FIGS. 7, 8, 9A, 9B, 9C, 10A, and 10B. The multi-layer composite body of the chord extension system 422, embodied as the flat plate 424, may include at least two composite layers of different elasticity parameters mechanically coupled together.

The chord extension systems 422 of FIG. 5A and 424 of FIG. 5A effectively increases the chord length of the wind turbine blade body 500. The extension in chord length may increase aerodynamic lift, locally, at the trailing edge 408 and thereby improve the aerodynamic performance of the wind turbine blade. Further, the multi-layer composite body of the chord extension system 422 is designed to deform or flex or buckle, with an increasing external mechanical force such as a wind load, in an intended direction, such that the increasing load is not added on to the trailing edge or the wind turbine blade. Furthermore, the multi-layer composite body of the chord extension system 422 regains its undeformed state when the external mechanical force (or wind load) is withdrawn. The whole chord extension system 422, thus acts as a passive performance (or aerodynamic lift) improvement system for the trailing edge without adding any load to the trailing edge under varying wind scenarios.

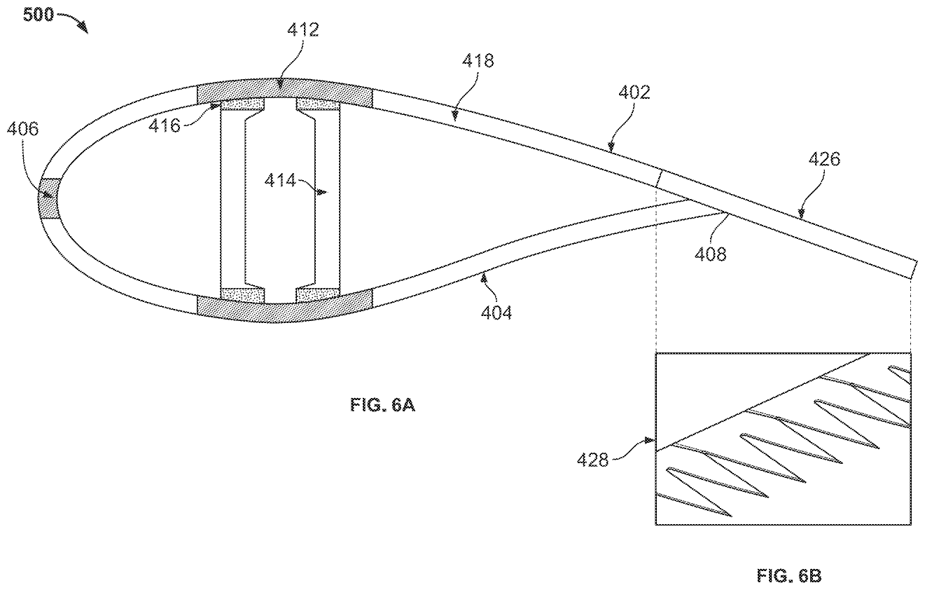

FIG. 6A is an illustrative cross-sectional view of a blade body 600 of a rotor blade of a wind turbine, in accordance with an embodiment of this disclosure. Referring to FIG. 6A, the blade body 600 may include the parts and components of a conventional rotor blade of a wind turbine, as described in relation to FIG. 4, such as outer shell 402, inner shell 404, leading edge 406, trailing edge 408, spar cap 412, shear webs 414, adhesive 416, and balsa or foam padding 418. In addition, the blade body 600 may include a chord extension system 426 mechanically coupled with the trailing edge 408 at the underside of the trailing edge 408. The chord extension system 428 may be coupled with the trailing edge 408 by an adhesive or screws or such other fastening mechanisms. The chord extension system 426 may be configured to enhance an aerodynamic performance of the wind turbine rotor blade.

FIG. 6B is an illustrative top view of the chord extension system 426 attached to the underside of the trailing edge 408 of the blade body 500 of the rotor blade of a wind turbine, in accordance with an embodiment of this disclosure. Referring to FIG. 6B, the chord extension system 426 may be embodied as a serration element 428 made of a multi-layer composite body, as described in more details below, in relation to FIGS. 7, 8, 9A, 9B, 9C, 10A, and 10B. The multi-layer composite body of the chord extension system 426, embodied as the serration element 428, may include at least two composite layers, of different elasticity parameters, mechanically coupled together.

The present disclosure relates to systems and methods of constructing passive trailing edge assemblies of FIGS. 5A, 5B, 6A, and 6B with predictable buckling responses under mechanical forces associated with extreme weather conditions. The systems and methods described herein may be designed to enhance the performance and efficiency of wind turbines and further, to optimize aerodynamic performance and passive load shedding while protecting and reducing structural stress. Specifically, various implementations of the disclosed subject matter relate generally to and may provide improvements in trailing edge assemblies in the way these assemblies respond to elastic buckling (or structural buckling) loads below and beyond critical buckling load yield points.

As is known in structural mechanics art, “elastic buckling” is a phenomenon that occurs when a slender structural component, such as a column or beam, yields under compressive loads, leading to sudden and catastrophic deformations. Elastic buckling occurring in fiberglass composite structures that are typically made of reinforcing fibers (e.g., glass fibers) embedded in polymer matrices (e.g., epoxy resin) is one of the design considerations for construction of robust wind turbine blades and their trailing edge assemblies.

In general, composite structures may utilize a combination of materials, typically fibers and a matrix, to create flexible laminates. The fibers, often made of materials like carbon or glass, provide strength, while the matrix, such as epoxy resin, allows flexibility. In practice, composite materials with varying properties may be employed to achieve the desired flexibility and strength. By carefully arranging and orienting the constituent materials, the composite structures may be enabled to endure repeated movements without compromising their structural integrity. This way, the composite structures are rendered adaptable for applications that require both strength and flexibility such as in trailing edges of wind turbine blades or in similar other mechanical structures.

Composite structures may exhibit elastic behavior up to a characteristic point, where stress is directly proportional to strain. Further, when fiberglass or such other composite structures are subjected to compressive load, they undergo elastic deformation until they reach critical buckling load yield points. Beyond this critical buckling load yield points, the structures become susceptible to buckling associated with a sudden increase in their lateral deflection.

In a designed configuration, when a composite structure includes two similar but different composite layers (with different fiber architectures and associated elastic yield properties, for instance) coupled together in an integrated or singular homogenous configuration and the composite structure is loaded with a compressive force, the structure may typically resist yielding until a critical yield point load is reached. Beyond the critical yield point load, the composite layer with the higher elastic yield properties is likely to yield first, defining a preconditioned direction of deformation for the integrated composite structure.

FIG. 7 is an illustrative view of a multi-layer composite body (also referred to as “composite structure”) 702 that may be used in the construction of the chord extensions system 422 of FIG. 5A or 424 of FIG. 5B or 426 of FIG. 6A or 428 of FIG. 6B. The composite structure 702 may include a first composite layer 704 and a second composite layer 706 that are mechanically coupled with each other. The first composite layer 704 and the second composite layer 706 may extend in a continuous manner with respect to each other and thereby may form the multi-layer composite structure 702 as a predominantly two-dimensional, homogenous structure, also referred to as a “laminate”.

The first composite layer 704 may have an associated first elasticity parameter and the second composite layer 706 may have an associated second elasticity parameter. The second elasticity parameter may be different from the first elasticity parameter. The first elasticity parameter may be a modulus of elasticity of the first composite layer 704, as is commonly applicable under externally applied stretching forces, or a buckling coefficient of the first composite layer 704, as applicable under externally applied compressive forces. In a similar manner, the second elasticity parameter may be a modulus of elasticity of the second composite layer 706, under externally applied stretching forces, or a buckling coefficient of the second composite layer 706 under externally applied compressive forces.

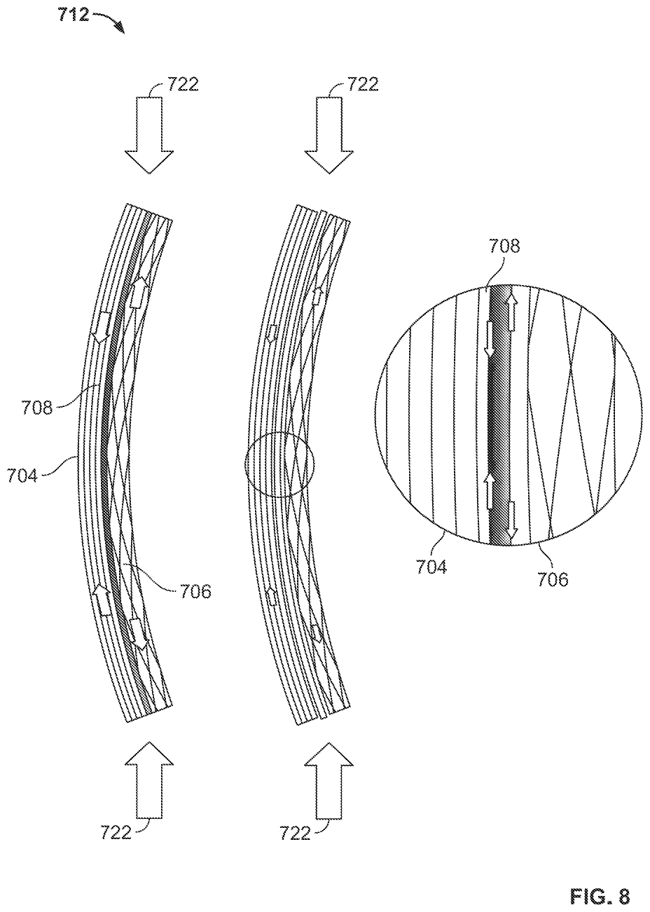

FIG. 8 is an illustrative view of an alternative embodiment 712 of the composite structure 702 of FIG. 7 that may be used in the construction of the chord extensions system 422 of FIG. 5A or 424 of FIG. 5B or 426 of FIG. 6A or 428 of FIG. 6B. Referring to FIG. 8, an adhesive layer 708 (such as thermoplastic polyurethane or TPU) may be inserted between and mechanically coupled with the first composite layer 704 and the second composite layer 706. The adhesive layer 708 may typically enhance the mechanical bonding, reduce the shear moment between the first composite layer 704 and the second composite layer 706 and prolong any degradation of the two layers by absorbing and deforming the TPU mass between the two layers.

Referring to FIG. 7 and FIG. 8, the first composite layer 704 and the second composite layer 706 may typically respond to a common external mechanical force 722, such as a stretching forces or a compressive force (or buckling force), in different manners owing to the fact that the second elasticity parameter may be different from the first elasticity parameter.

As is commonly known in elastic deformation art, the first composite layer 704 and the second composite layer 706 may continue to remain in their respective undeformed initial states when the common external mechanical force 722 increases from an initial no-load condition until respective predetermined yield points are reached. The yield point for the first composite layer 704 may be predetermined and/or designed and/or controlled to be different from the yield point for the second composite layer 706.

Referring back to FIG. 7 and FIG. 8, with further increase in the common external mechanical force 722 beyond the respective predetermined yield points, the first composite layer 704 and the second composite layer 706 may deform in accordance with Young's law of stress and strain (also known as “Young's law of elasticity”) and/or further, in accordance with an equivalent law of elastic deformation under buckling load. Specifically, the first composite layer 704 and the second composite layer 706 may deform linearly when the common external mechanical force 722 increases beyond the respective predetermined yield points. Further, the first composite layer 704 and the second composite layer 706 may regain their respective initial undeformed states when the common external mechanical force 722 is withdrawn or it ceases to exist.

The present disclosure provides a way to differentially configure the two layers such that when one layer is stretched, the other may be compressed or vice versa. As a result, the singular laminate (702 of FIG. 7 or 712 of FIG. 8), as a homogenous composite structure with an unbalanced fiber architecture, performs like a spring under external mechanical forces. Once deflection occurs under a buckling load, the composite structure (702 of FIG. 7 or 712 of FIG. 8) yields continuously at or around that same load. When the buckling load decreases below the critical yield point, the laminate returns to its original flat, pre-buckle state. The direction of the bend (or buckle) and the load may be controlled by choosing a number of design factors such as the materials of the two composite layers, their thickness and the architecture of the fibers. For example, the fiber(s) in the first composite layer 704 and/or the second composite layer 706 may be unidirectional fibers in an instance. In an instance, one of the composite layers may have unidirectional fibers and the other composite layer may have biaxial fibers. Further, the biaxial fibers may be stitched, as a non-limiting example, in a 45/−45 weave or any other variable and customizable orientation.

When employed in the trailing edge of a wind turbine blade, the composite structure may perform like and have the effect of a passive load controlling and shape restoring mechanism. Further, when the load is withdrawn or ceased the passive load controlling and shape restoring mechanism, i.e., the composite structure (702 of FIG. 7 or 712 of FIG. 8) may bring a deformed trailing edge back to its original undeformed state.

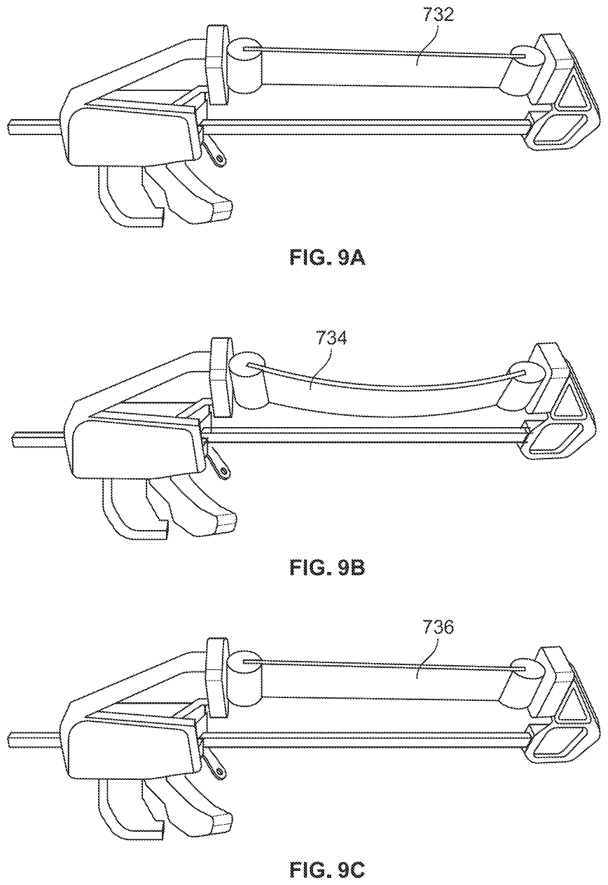

FIG. 9A is an illustrative view of the composite structure 732 (702 of FIG. 7 or 712 of FIG. 8) under no-load condition, i.e., when there is no common external mechanical force 722 (of FIG. 7 and FIG. 8). As is commonly known in elastic deformation art, the first composite layer 704 and the second composite layer 706 remain in respective undeformed states when the common external mechanical force 722 increases from an initial no-load condition until respective predetermined yield points are reached. The yield point for the first composite layer 704 may be designed and controlled to be different from the predetermined yield point for the second composite layer 706.

FIG. 9B is an illustrative view of the composite structure 734 (702 of FIG. 7 or 712 of FIG. 8) when the common external mechanical force 722 (of FIG. 7 and FIG. 8) is increased beyond the respective predetermined yield points. The first composite layer 704 and the second composite layer 706 may deform in accordance with Young's law of elasticity and/or further, in accordance with equivalent law of elastic deformation under buckling load. Specifically, the first composite layer 704 and the second composite layer 708 may deform linearly when the common external mechanical force 722 increases beyond the respective predetermined yield points.

FIG. 9C is an illustrative view of the composite structure 736 (702 of FIG. 7 or 712 of FIG. 8) under no-load condition, i.e., when the common external mechanical force 722 (of FIG. 7 and FIG. 8) is withdrawn and the first composite layer 704 and the second composite layer 706 have regained their respective undeformed states.

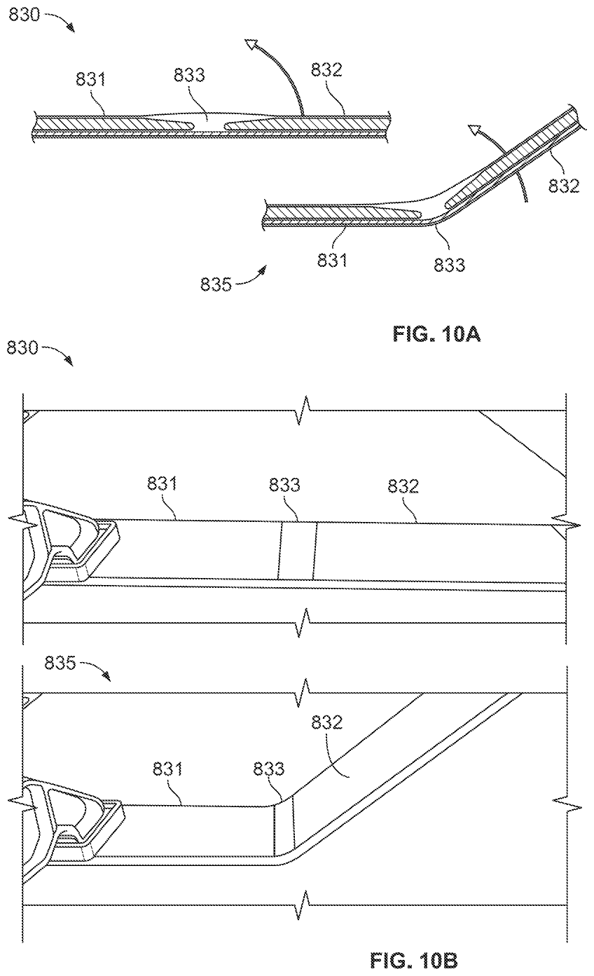

FIG. 10A is an illustrative side view of an alternative embodiment composite structure 830 (702 of FIG. 7 or 712 of FIG. 8) under no-load condition, i.e., when there is no common external mechanical force 722 (of FIG. 7 and FIG. 8). FIG. 10A further includes an illustrative side view 835 of the alternative embodiment composite structure (also referred to as “composite hinge”) 830 (702 of FIG. 7 or 712 of FIG. 8) under load condition, i.e., when the common external mechanical force 722 (of FIG. 7 and FIG. 8) is acting.

FIG. 10B is an illustrative perspective view of the alternative embodiment composite structure 830 under no-load condition, i.e., when there is no common external mechanical force 722 (of FIG. 7 and FIG. 8). FIG. 10B further includes an illustrative perspective view 835 of the alternative embodiment composite structure (or composite hinge) 830 under load condition, i.e., when the common external mechanical force 722 (of FIG. 7 and FIG. 8) is acting.

Referring to FIGS. 10A and 10B, the alternative embodiment first composite layer (704 of FIG. 7 and FIG. 8) may include two transverse parts 831 and 832 joined by a flexible folding zone 833. The two transverse parts 831 and 832 and the folding zone 833 form a reversibly foldable and substantially two-dimensional homogenous composite hinge structure. As is commonly known in elastic deformation art, the alternative embodiment first composite layer 704, the two transverse parts 831 and 832, the folding zone 833, and the alternative embodiment second composite layer 706 remain in respective undeformed or flat states when the common external mechanical force 722 increases from an initial no-load condition until respective predetermined yield points are reached. The yield point for the alternative embodiment first composite layer 704 may be designed and controlled to be different from the predetermined yield point for the alternative embodiment second composite layer 706.

Under a further increase in the common external mechanical force (722 of FIG. 7 and FIG. 8) beyond the respective predetermined yield points, the two transverse parts 831 and 832 of the alternative embodiment first composite layer (704 of FIG. 7 and FIG. 8) and the alternative embodiment second composite layer (706 of FIG. 7 and FIG. 8) may deform in accordance with Young's law of elasticity and/or further, in accordance with equivalent law of elastic deformation under buckling load. Specifically, the two transverse parts 831 and 832 of the alternative embodiment first composite layer (704 of FIG. 7 and FIG. 8) and the alternative embodiment second composite layer (706 of FIG. 7 and FIG. 8) may deform linearly when the common external mechanical force 722 increases beyond the respective predetermined yield points and bend about the folding zone 833, forming the reversible folded composite hinge structure (or composite hinge) 835.

Thus, the composite hinge structure 830 (in flat state) or 835 (in folded state) of FIGS. 10A and 10B may utilize a combination of materials, typically composite fibers and a matrix, to create a flexible joint. The composite materials may be designed to have varying properties to achieve desired flexibility and strength. As an example, the composite fibers may be made of materials such as carbon or glass to provide strength, while the matrix may be made of materials such as epoxy resin to provide flexibility. By carefully arranging and orienting the composite fibers and the matrix, the composite hinge structure 830 (in flat state) or 835 (in folded state) may be enabled to endure repeated movement without compromising its structural integrity, thereby making it well-suited for applications where both strength and flexibility are essential, such as in trailing edges of wind turbine blades, aircraft wings or such other mechanical structures.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is illustrative and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A wind turbine rotor blade comprising:
a blade body having a shape that generates a lift when impacted by an incident airflow, wherein the blade body comprises a pressure side and a suction side joining at a leading edge, and a trailing edge; and
a chord extension system mechanically coupled with the trailing edge, the chord extension system configured to enhance an aerodynamic performance of the wind turbine rotor blade,
wherein the chord extension system comprises a flat plate or a serration,
wherein the chord extension system comprises a multi-layer composite body comprising:
a first composite layer having a first elasticity parameter; and
a second composite layer mechanically coupled with the first composite layer, the second composite layer having a second elasticity parameter different from the first elasticity parameter.

2. The wind turbine rotor blade of claim 1, wherein either the first composite layer and the second composite layer extend in a continuous manner with respect to each other, forming a substantially two-dimensional, homogenous structure, or the first composite layer comprises at least two transverse parts joined by a flexible folding zone, the at least two transverse parts and the folding zone forming a reversibly foldable and substantially two-dimensional homogenous structure.

3. The wind turbine rotor blade of claim 2, wherein the first elasticity parameter comprises a first modulus of elasticity and a first buckling coefficient and the second elasticity parameter comprises a second modulus of elasticity and a second buckling coefficient.

4. The wind turbine rotor blade of claim 3, wherein the first composite layer and the second composite layer respond to a common external mechanical force in a different manner.

5. The wind turbine rotor blade of claim 4, wherein the common external mechanical force comprises a stretching force and a buckling load.

6. The wind turbine rotor blade of claim 5, wherein the first composite layer and the second composite layer remain in respective undeformed states with a first increase in the common external mechanical force until respective predetermined yield points are reached, wherein a first predetermined yield point for the first composite layer is different from a second predetermined yield point for the second composite layer.

7. The wind turbine rotor blade of claim 6, wherein the first composite layer and the second composite layer deform with a second increase in the common external mechanical force beyond the respective predetermined yield points.

8. The wind turbine rotor blade of claim 7, wherein the first composite layer and the second composite layer deform linearly under the second increase in the common external mechanical force beyond the respective predetermined yield points.

9. The wind turbine rotor blade of claim 7, wherein the first composite layer and the second composite layer regain respective undeformed states when the common external mechanical force is withdrawn.

10. The multi-layer composite body of claim 7, wherein the at least two transverse parts of the first composite layer and the second composite layer bend about the folding zone under the second increase in the common external mechanical force beyond the respective predetermined yield points, forming a reversible folded structure.

11. The wind turbine rotor blade of claim 2 further comprising an adhesive layer inserted between and mechanically coupled with the first composite layer and the second composite layer, the adhesive layer configured to enhance a mechanical bonding, and reduce a shear moment between the first composite layer and the second composite layer.

12. The wind turbine rotor blade of claim 2, wherein the at least two transverse parts comprise two transverse parts.

13. A wind turbine comprising one or more wind turbine rotor blades, the one or more wind turbine rotor blades comprising the chord extension system of claim 1.

14. A wind turbine rotor blade comprising:
a blade body having a shape that generates a lift when impacted by an incident airflow, wherein the blade body comprises a pressure side and a suction side joining at a leading edge, and a trailing edge; and
a chord extension system mechanically coupled with the trailing edge, the chord extension system configured to enhance an aerodynamic performance of the wind turbine rotor blade,
wherein the chord extension system comprises a flat plate or a serration,
wherein the chord extension system comprises a multi-layer composite body comprising:
a first composite layer having a first elasticity parameter; and
a second composite layer mechanically coupled with the first composite layer, the second composite layer having a second elasticity parameter different from the first elasticity parameter,
wherein either the first composite layer and the second composite layer extend in a continuous manner with respect to each other, forming a substantially two-dimensional, homogenous structure, or the first composite layer comprises at least two transverse parts joined by a flexible folding zone, the at least two transverse parts and the folding zone forming a reversibly foldable and substantially two-dimensional homogenous structure,
wherein the first elasticity parameter comprises a first modulus of elasticity and a first buckling coefficient and the second elasticity parameter comprises a second modulus of elasticity and a second buckling coefficient,
wherein the first composite layer and the second composite layer respond to a common external mechanical force in a different manner.

15. The wind turbine rotor blade of claim 14, wherein the at least two transverse parts comprise two transverse parts.
